(19) United States
(12) Patent Application Publication
(10) Pub. No.: US 2002/0167546 A1
(43) Pub. Date: Nov. 14, 2002

(54) Picture stack

(76) Inventors: Benjamin D. Kimbell, Fort Collins, CO (US); Lisa M. Geer, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/854,037

(22) Filed: May 10, 2001

(51) Int. Cl. G06F 3/14

(52) U.S. Cl. 345/790; 345/793

(57) ABSTRACT

Images are presented to a user directly on the desktop of a graphical user interface in the stylized form of a picture stack, where the user can move among images in the stack by clicking on the stack. Such images may include photographic images captured by a digital camera or scanned into an information handling system.

### FIELD OF THE INVENTION

This invention relates to photography, and more particularly to organizing and displaying photographic images.

### BACKGROUND

Digital photography has gained in popularity in recent years, due to the convenience it offers. Digital photographs may be taken with a digital camera and saved to a personal computer or other information handling system. Further, with the advent of inexpensive scanners, print photographs can be scanned into digital form for storage on an information handling system. Those digital photographs may then be viewed on the information handling system, or transmitted by electronic mail or other means to another information handling system to be viewed by another user.

Typically, digital photographs are saved as image files in a particular format, and are viewed via a software program that opens the image files and displays the photographic images on a display connected to the information handling system. In a typical graphical user interface, such as Microsoft's Windows or Apple's Macintosh OS, the photographic images are displayed in one or more windows placed over a desktop. Such windows each typically include a frame surrounding a client area in which the photographic data is displayed. The frame typically includes a vertical scroll bar on one side and a horizontal scroll bar at the bottom, to allow a user to move the photographic image in the client area. The frame typically also includes icons for minimizing the window, reducing its size, and closing it, as well as a menu bar at the top listing commands that a user click upon to display a menu beneath. The frame typically also includes one or more toolbars for performing image manipulation and enhancement, or other controls useful for handling the image in the client area.

While the person who took the photographs and transferred them to the information handling system may be familiar with computer technology and the software program used to view them, other users of the computer or recipients of image files containing those images may not be. Indeed, some users may be uncomfortable with the information handling system and its use. When the photographic images are displayed in a window having the features described above, the user can easily become confused by the number of controls and their functions. For example, the user may be unable to determine how to control the window, or view additional photographic images in a group of images. Some software programs may also display different photographic images at different sizes, depending on the resolution of the image. This may be confusing to a user who does not know how to use the scroll bars on the window, or how to resize the image, in order to view the entire image. As a result, the user may simply give up, missing the opportunity to view and enjoy the photographic images stored in it.

### SUMMARY

Images are presented to a user directly on the desktop of a graphical user interface in the stylized form of a picture stack, where the user can move among images in the stack by clicking on it.

In one aspect of the invention, one or more images are presented to a user directly on the desktop of a graphical user interface. Multiple images are conceptually stacked together, and may be slightly offset from one another to provide the appearance of a stack of photographs. One or more of the images may have a border, to distinguish it from the desktop and from other images in the stack. Multiple images may be sized substantially the same, in the manner of photographic prints. By displaying the images directly on the desktop, the user is presented with a simple and familiar real-world model for viewing a number of images in a stack, so that the user can easily view the images in a straightforward manner.

In another aspect of the invention, the user may click at any location on the picture stack to bring up a new image. The image previously at the top of the stack may be sent to the bottom of the picture stack, removed from the picture stack altogether, or otherwise handled. By allowing a user to click anywhere on the picture stack to bring up a new image, the user can easily move among photographs in a manner similar to looking through a stack of photographic prints.

In another aspect of the invention, audio data associated with the top image in the picture stack is played automatically. The user need not make an attempt to determine if the image is associated with audio data, nor locate and manipulate controls in order to play that audio data. The audio data is played automatically to improve convenience and usability.

In another aspect of the invention, a toolbar may be provided on the display separate from the picture stack. The toolbar may include controls useful to an advanced user, such as controls relating to image manipulation or transmission. In this way, advanced users can perform actions on the images within the picture stack, without complicating the interface for less-advanced users who simply wish to look at images.

The invention will be more fully understood upon consideration of the detailed description below, taken together with the accompanying drawings.

### BRIEF DESCRIPTION OF THE DRAWINGS

FIG. 1 is a block diagram of an information handling system.

FIG. 2 is a front view of a display on which photographic data is shown.

FIG. 3 is a flow chart of a method for viewing images on the information handling system.

FIG. 4 is a block diagram of a picture stack.

FIG. 5 is a front view of a display on which photographic data is shown, including a toolbar separate from the photographic images displayed.

Use of the same reference symbols in different figures indicates similar or identical items.

### DETAILED DESCRIPTION OF THE PREFERRED EMBODIMENTS

Referring to FIG. 1, an information handling system 100 is shown. The information handling system 100 may be a personal computer, an Internet appliance, a personal digital assistant (PDA), a thin client, a wireless telephone, or any other device adapted to handle analog or digital information. The information handling system 100 includes a controller 102 that controls the operation of the information handling system 100. The controller 102 may be a microprocessor, an application-specific integrated circuit (ASIC), field-programmable gate array (FPGA), or any other device adapted to control an information handling system 100. The controller 102 is standard.

In one embodiment, a data storage unit 104 is included in the information handling system 100, and is electrically connected to the controller 102. The data storage unit 104 may be a hard drive, flash memory, a removable disk cartridge, a compact disk, an optical disk, or any other device adapted to store data. The operation of the data storage unit 104 is standard. In another embodiment, the data storage unit 104 is located outside the information handling system 100, but is connected to the information handling system 100 via the controller 102. In such an embodiment, the data storage unit 104 may be a remote server, storage area network, information handling system, or other device remotely accessible by the information handling system 100 via a communications network such as the Internet.

The information handling system 100 may be connectable to a digital camera 106. The digital camera 106 may be connected to the information handling system 100 via a serial connection, a USB port, an infrared or other wireless connection, a local area network, or another type of connection. After connecting to the information handling system 100, the digital camera 106 can transmit or download data, such as image and audio data, to the data storage unit 104 via the controller 102. The digital camera 106, the connection of a digital camera 106 to an information handling system 100, and the transmission of data from that camera 106 to the information handling system 100 are standard.

The information handling system 100 may be connectable to a scanner 108. The scanner 108 may be connected to the information handling system 100 via a serial connection, a USB port, an infrared or other wireless connection, a local area network, or another type of connection. After connecting to the information handling system 100, the scanner 108 can transmit or download data, such as image and audio data, to the data storage unit 104 via the controller 102. The scanner 108, the connection of a scanner 108 to an information handling system 100, and the transmission of data from that scanner 108 to the information handling system 100 are standard.

The information handling system 100 includes or is electrically connected to a display 110 via the controller 102. The display 110 is standard, and may be a cathode ray tube, a liquid crystal display, a plasma display, or any other type of display adapted to display information such as images and text to one or more users.

The information handling system 100 includes or may be electrically connected to one or more speakers 112 via the controller 102. Speakers are standard, and may be any type of speakers over which audio data can be played back to one or more users.

The information handling system 100 may include or be connected to a pointing device 114 via the controller 102. The pointing device 114 may be a mouse, trackball, touchpad, or any other device adapted to move a pointer on the display 110 in the context of a graphical user interface. The pointing device 114 also includes a selection control, such as a mouse button, through which a user can click on or otherwise select an item on the display to which the pointer is pointing. The use of a pointing device 114 in conjunction with a graphical user interface is standard in the art.

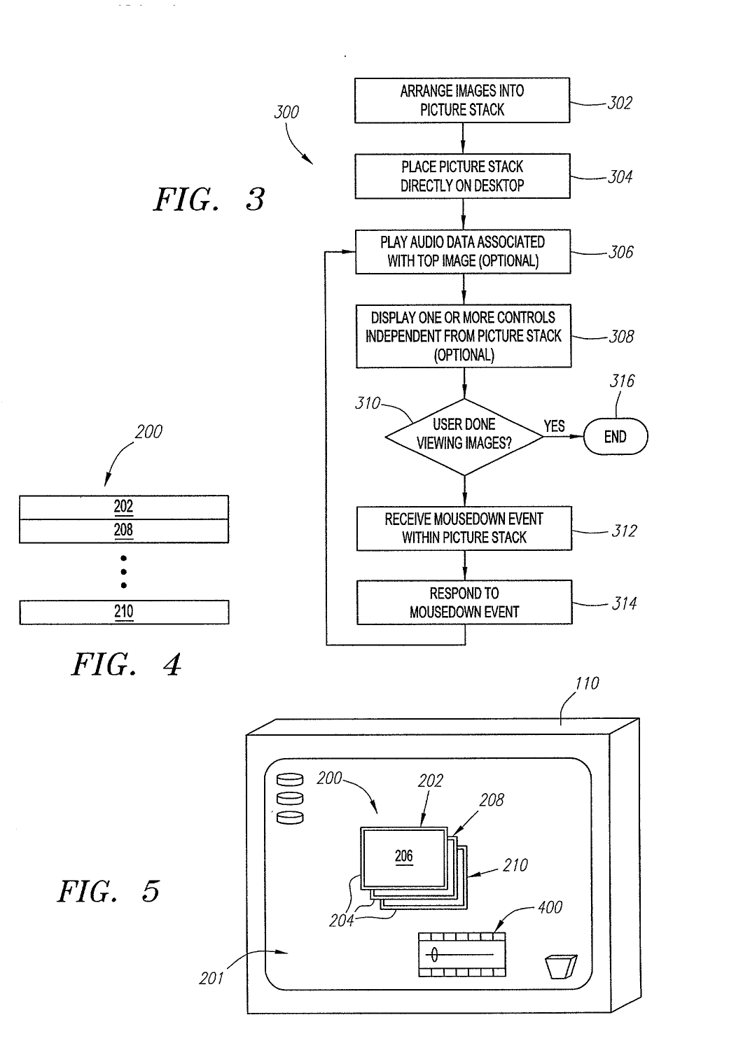

Referring as well to FIG. 3, a method 300 is shown for viewing images via an information handling system utilizing a graphical user interface having a desktop. In block 302, two or more images are arranged into a picture stack. In one embodiment, the images are retrieved from the data storage unit 104 and arranged into a picture stack by the controller 102. Referring as well to FIG. 4, a block diagram of the picture stack 200 is shown. The picture stack 200 is a conceptual structure into which image data is organized. The picture stack 200 includes a top image 202 and a bottom image 210, and may include one or more intermediate images 208. In one embodiment, the picture stack 200 is organized such that the top image 202 is the image viewed by a user at any particular time, and the other images are substantially not shown to the user at that particular time, as described in greater detail below. In other words, the picture stack 200 defines an order in which the images 202, 208, 210 within it are shown to a user. While the picture stack 200 is shown with three images 202, 208, 210 for clarity in explaining the structure and use of the stack 200, the picture stack 200 may include more images or fewer images, if desired.

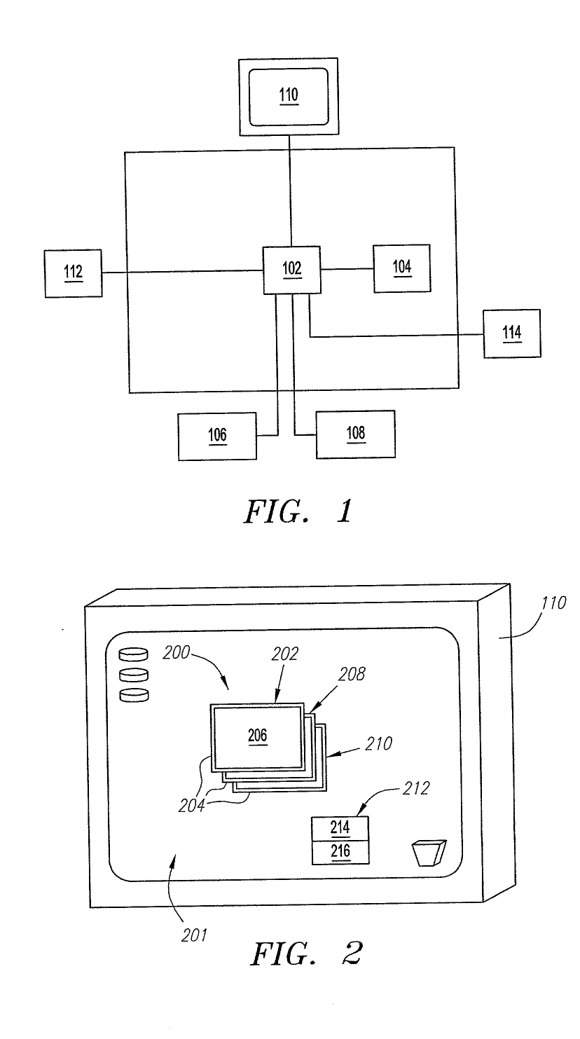

Next, in block 304, the picture stack 200 is placed directly on the desktop of a graphical user interface displayed on the display 110. Referring as well to FIG. 2, the picture stack 200 is shown as placed directly on the desktop 201. That is, the picture stack 200 is displayed on the desktop 201 outside of a traditional window or frame, such that scroll bars, menu bars, toolbars, and other such controls are not attached to, and do not frame, the picture stack 200. In this way, the presentation of images to a user is simplified, and the user need not contend with a number of potentially-unfamiliar tools, controls, menu headings and the like.

The picture stack 200 has a top image 202. In one embodiment, the top image 202 of the picture stack 200 includes a border 204 around image data 206. The border 204, if used, may be several pixels wide. In one embodiment, the border 204 has no unique active control functionality assigned specifically to it. Rather, the border 204 simply serves to distinguish the image data 206 from the desktop 201 of the graphical user interface. The border 204 of each image 202, 208, 210 may be the same size, or the border 204 may be a different width for one or more of the images 202, 208, 210. The border 204 is optional, and need not be utilized.

In one embodiment, the images 202, 208, 210 in the picture stack 200 are offset from one another to provide an illusion of a three-dimensional stack of pictures. In such an embodiment, a separate border 204 may be provided for each image 202, 208, 210, where the border 204 of each image 208, 210 substantially ends at the intersection with the border 204 of the image above it in the picture stack 200. The borders 204 may be the same width for each image 202, 208, 210, or may be different widths, if desired. In another embodiment, a border 204 is only provided for the top image 202.

Each image 202, 208, 210 in the picture stack 200 may be substantially the same size, in the same manner as photographic prints. However, one or more of the images 202, 208, 210 may vary in size from one another, if desired. Where the images 202, 208, 210 have varying sizes, the border 204 of each image may proportionally vary in width, if desired.

Block 306 is optional. Some digital cameras 106 include a sound detection device (not shown) such as a microphone, allowing a user to capture audio data in association with a photograph. The capture of such audio data and its association with particular image data is known. If such audio data is associated with the image data, the audio data associated with the top image 202 is played automatically in block 306 when the top image 202 is displayed. The audio data may be stored in the data storage unit 104 or in another location, and need not be stored in physical proximity to the image data. The audio data may be played back through the speaker or speakers 112 via the controller 102, or through one or more other sound generation devices connected to the information handling system 100. If no audio data is associated with the top image 202, block 306 is omitted. Further, block 306 may be omitted even if audio data is associated with the top image 202; in such an embodiment, the audio data is not automatically played, and the user may click on an icon or activate another control in order to listen to the audio data.

Next, in block 308, a set of one or more controls maybe displayed on the display 201, independent of the picture stack 200. Block 308 is optional. In one embodiment, a simple console 212 is placed on the desktop independent of the picture stack 200. The console 212 is designed to have a small number of simple controls to facilitate use of the picture stack 200. For example, the console 212 may allow the user to stop displaying the picture stack 200 by clicking on a first button 214, and/or may allow the user to toggle a toolbar having additional functions by clicking on a second button 216.

In another embodiment, referring as well to FIG. 5, a toolbar 400 may be displayed on the display 201 independent of the picture stack 200. The toolbar 400 may include one or more controls that are useful for advanced users, but that are not necessary for the basic operation of the picture stack 200. Such controls may include additional controls for navigating through the picture stack 200, for processing, manipulating or altering one or more images, for replaying audio data associated with an image, for mailing or transmitting one or more images to a different information handling system, or other functions. The toolbar 400 may be brought up on the desktop 201 as a consequence of the user clicking on the second button 216 of the console 212, or via other means. Because the presence of the toolbar 400 is optional, the operation of the picture stack 200 can be tailored to the experience level of the user. Other means may be used to control the picture stack 200, without the use of the console 212 or the toolbar 400. For this reason, block 308 is optional.

Two or more of blocks 304, 306 and 308 may be performed substantially simultaneously, if desired. For example, the console 212 may be displayed at substantially the same time as the picture stack 200 is placed on the desktop 201.

Next, in block 310, after viewing the top image 202, and listening to any audio data that may be associated with it, the user may be done viewing images. If so, the process 300 moves to block 316, in which the process ends. In one embodiment, the picture stack 200 is removed automatically from the desktop 201 in block 316. If the user wishes to view additional images, the process 300 moves from block 310 to block 312. In block 312, the user clicks on the picture stack 200, such that a mousedown event is generated, where the mousedown event has a location within the picture stack 200. Detection of a mousedown event in a particular location within a graphical user interface is standard in the art. In the context of a graphical user interface, a mousedown event is generated when a user depresses a button on a mouse, trackpad or other pointing device, or otherwise selects an area on the display 110 with the pointing device 114. A mousedown event is associated with the particular location on the display 110 of the pointer controlled by the pointing device 114.

The picture stack 200 defines an area on the desktop 201. The defined area may be rectangular, or may take on a more complex shape if the images 202, 208, 210 are offset from one another in the picture stack. That is, the edges of the picture stack 200 as displayed on the desktop 201 enclose an area that is defined by the picture stack 200. If a mousedown event occurs within that defined area, the user has clicked on the picture stack 200. The controller 102 senses that the mousedown event has occurred, and senses the location associated with that mousedown event, thereby determining whether a mousedown event has taken place within the picture stack 200.

Next, in block 314, the controller 102 responds to the mousedown event sensed in block 312. In one embodiment, the top image 202 is moved to the bottom of the picture stack 200, and the second image 206 that had been underneath the top image 200 moves to the top of the picture stack 200. In this way, a user can move through the images in the picture stack 200 simply by clicking on the picture stack 200, without the need to utilize other controls. In another embodiment, the controller 102 may respond to the mousedown event sensed in block 310 in a different way. For example, the top image 202 may be removed from the picture stack 200 altogether, such that the second image 206 that had been underneath the top image 200 is displayed. The process 300 then moves to block 306.

In one embodiment, instructions for implementing the method 300 are provided as a computer program product. A computer program product is a set of instructions for a device such as a controller 102. The computer program product may be stored on the data storage unit 104. The computer program product may be received into the information handling system 100 via a communications network, a compact disc, a removable hard disk, a removable optical disk, flash memory, or any other hardware, network, device or method capable of storing and/or transmitting data.

Although the invention has been described with reference to particular embodiments, the description is only an example of the invention's application and should not be taken as a limitation. Consequently, various adaptations and combinations of features of the embodiments disclosed are within the scope of the invention as defined by the following claims and their legal equivalents.

What is claimed is:

1. A method for viewing images via an information handling system utilizing a graphical user interface having a desktop, the method comprising:
displaying a plurality of images;
arranging said plurality of images into a picture stack comprising a top and bottom; and
placing said picture stack directly on the desktop of the graphical user interface, wherein said top image of said picture stack is displayed.

2. The method of claim 1, wherein said plurality of images are photographic images.

3. The method of claim 1, wherein said placing comprises offsetting said plurality of images from one another.

4. The method of claim 1, wherein said plurality of images are substantially the same size as one another.

5. The method of claim 1, further comprising:
receiving a mousedown event within the picture stack; and
responding to said mousedown event.

6. The method of claim 5, wherein a second image is positioned behind said top image; and wherein said responding comprises:
moving said top image to said bottom of said picture stack; and
moving said second image to said top of said picture stack.

7. The method of claim 1, wherein audio data is associated with said top image, further comprising playing said audio data when said top image is displayed.

8. The method of claim 1, further comprising displaying on the desktop at least one control separate from said picture stack.

9. The method of claim 8, wherein said displaying comprises displaying a toolbar.

10. The method of claim 8, further comprising receiving the selection of a control on is said toolbar.

11. The method of claim 1, wherein at least one of said plurality of images comprises a border.

12. A method for viewing images via an information handling system utilizing a graphical user interface having a desktop, the method comprising:
displaying a plurality of images;
arranging said plurality of images into a picture stack comprising a top and bottom, at least one of said images comprising a border, wherein a second image is positioned behind said top image; and
placing said picture stack directly on the desktop of the graphical user interface, wherein said top image of said picture stack is displayed;
receiving a mousedown event within the picture stack;
moving said top image to said bottom of said picture stack; and
moving said second image to said top of said picture stack.

13. A computer program product for use with an information handling system utilizing a graphical user interface having a desktop, the computer program product comprising:
instructions for displaying a plurality of images;
instructions for arranging said plurality of images into a picture stack comprising a top and bottom; and
instructions for placing said picture stack directly on the desktop of the graphical user interface, wherein said top image of said picture stack is displayed.

14. The computer program product of claim 13, further comprising:
instructions for receiving a mousedown event within the picture stack; and
instructions for responding to said mousedown event.

15. The computer program product of claim 14, wherein a second image is positioned behind said top image; and wherein said instructions for responding comprise:
instructions for moving said top image to said bottom of said picture stack; and
instructions for moving said second image to said top of said picture stack.

16. The computer program product of claim 13, wherein audio data is associated with said top image, further comprising instructions for playing said audio data when said top image is displayed.

17. The computer program product of claim 13, further comprising instructions for displaying on the desktop at least one control separate from said picture stack.

18. The computer program product of claim 17, further comprising instructions for is receiving the selection of at least one said control.
